(19) United States
(12) Patent Application Publication
(10) Pub. No.: US 2021/0274747 A1
(43) Pub. Date: Sep. 9, 2021

(54) Pet Leash with Built-in Tie Out Stake

(71) Applicant: Michael Tyler Sells, Mexico, MO (US)

(72) Inventor: Michael Tyler Sells, Mexico, MO (US)

(21) Appl. No.: 16/810,563

(22) Filed: Mar. 5, 2020

(51) Int. Cl. A01K 3/00; A01K 27/00

(52) U.S. Cl. CPC A01K 3/00; A01K 27/004

(57) ABSTRACT

It is an objective of the present invention to provide users with a retractable dog leash that has a built-in tie out stake. According to the present invention, the tie out stake is built into the handle and comprises a locking mechanism that securely holds the tie out stake in two different configurations. It is an aim of the present invention to have the tie out stake stored safely in a collapsed position when not in use, and have the tie out stake pulled and rotated to a deployed configuration, when needed to be struck in the ground. The present invention further comprises a protective shroud and a fastener, that holds the tie out stake in a protective enclosure when in the collapsed state. Thus, the present invention provides pet owners a new ability to have their pet tied in better spaces where there are no obstacles.

### FIELD OF THE INVENTION

The present invention relates generally to a dog leash. More specifically, the present invention relates to a dog leash comprising a built-in tie out stake, wherein the tie out stake has two dispositional modes.

### BACKGROUND OF THE INVENTION

Dog owners often find it difficult to find a good outdoor spot with plenty of room and a post, where they can keep their dog confined to, by tethering the dog leash to the post. Often times the leashes have to be tied to a chair or a pillar or pole, that would have many obstacles nearby, which leads to tangling of the leash cord, as the dog plays around. Small dog owners face the problem of fumbling around with the dog leash and end up spending a lot of time untangling the leash cord, when they tie the dog leash close to them and the dog runs around them. Portable retractable pet leads or stationary retractable pet leads can be a temporary solution to the above-mentioned problem. However, outdoor situations arise unplanned most of the time and it is also difficult to remember and carry the additional lead attachment every time pet owners take their pet outside for a stroll. Thus, a pet leash and a tie out stake carried together in a compact fashion could be a solution to the above-mentioned problems.

It is an objective of the present invention to provide users with a retractable dog leash that has a built-in tie out stake. According to the present invention, the tie out stake is built into the handle and comprises a locking mechanism that securely holds the tie out stake in two different configurations. It is an aim of the present invention to have the tie out stake stored safely in a collapsed position when not in use, and have the tie out stake pulled and rotated to a deployed configuration, when needed to be struck in the ground. Further, the locking mechanism allows a user to alternate the tie out stake between a collapsed state and a deployed state, that are 90 degrees apart, and lock the tie out stake in both positions, thereby eliminating the danger of having an unstable or hanging tie-out stake. The present invention further comprises a protective shroud and a fastener, that holds the tie out stake in a protective enclosure when in the collapsed state. Thus, the present invention provides pet owners a new ability to have their pets tied in better outdoor spaces where there are no obstacles, thereby encouraging pet owners to include their pets in more outdoor activities.

### BRIEF DESCRIPTION OF THE DRAWINGS

FIG. 1 is a top-front-left perspective view of the present invention, wherein the built-in tie out stake is in a deployed configuration.

FIG. 2 is a bottom-rear-right perspective view of the present invention, wherein the built-in tie out stake is in the deployed configuration.

FIG. 3 is a top-front-right perspective view of the present invention, wherein the built-in tie out stake is in the deployed configuration.

FIG. 4 is a front elevational view of the present invention, wherein the built-in tie out stake is in a collapsed configuration.

FIG. 5 is a front elevational view of the present invention, wherein a front cover of the leash body is made transparent, to reveal the leash reel.

FIG. 6 is a rear elevational view of the present invention, wherein the built-in tie out stake is in the collapsed configuration.

FIG. 7 is a top-front-left perspective view of the tie out stake and the locking mechanism.

FIG. 8 is a detailed view of section 8 of FIG. 7.

### DETAIL DESCRIPTIONS OF THE INVENTION

All illustrations of the drawings are for the purpose of describing selected versions of the present invention and are not intended to limit the scope of the present invention.

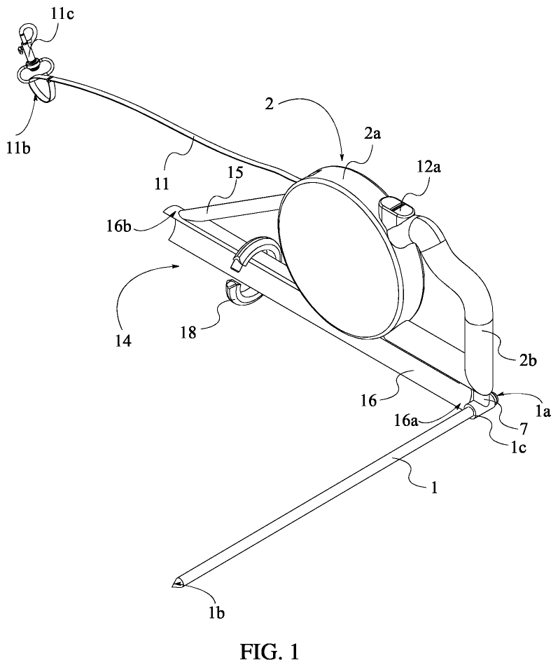

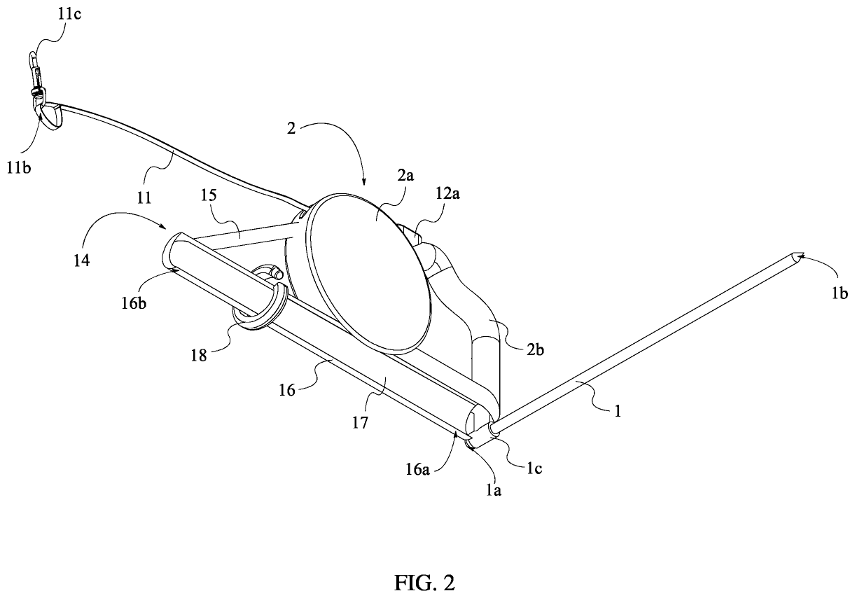

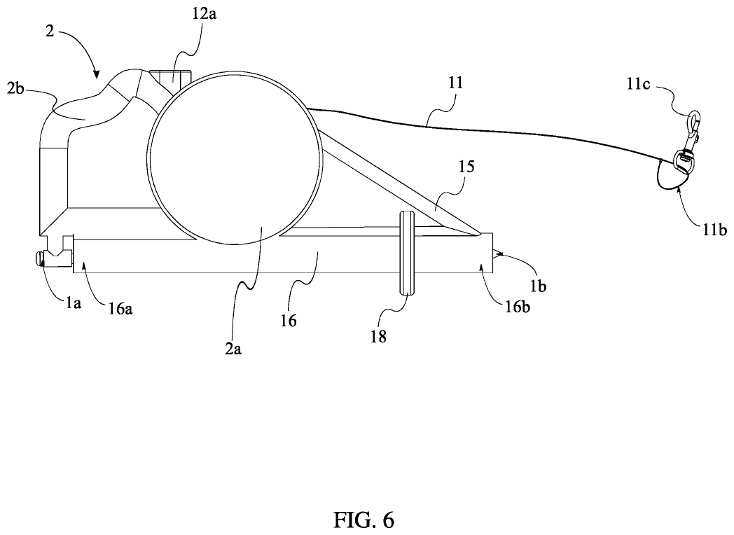

In reference to FIG. 1 through FIG. 8, the present invention is a dog leash. It is an objective of the present invention to provide users with a retractable dog leash that has a built-in tie out stake. According to the present invention, the tie out stake is built into the handle and comprises a locking mechanism that securely holds the tie out stake in two different configurations. It is an aim of the present invention to have the tie out stake stored safely in a collapsed position when not in use, and have the tie out stake pulled and rotated to a deployed configuration, when needed to be stuck in the ground. Accordingly, the locking mechanism allows a user to alternate the tie out stake between a collapsed state and a deployed state, that are 90 degrees apart, and lock the tie out stake in both states, thereby eliminating the danger of having an unstable tie-out stake, especially in situations like running with pet. Accordingly, the present invention further comprises a protective shroud and a fastener, that holds the tie out stake in a protective enclosure when in the collapsed state. Thus, the present invention provides pet owners a new ability to have their pets tied in better spaces where there are no obstacles, and thus encourage to include their pets in more outdoor activities.

The following description is in reference to FIG. 1 through FIG. 8. As seen in FIG. 1 through FIG. 8, the retractable dog leash comprises a tie out stake 1, a leash 2, and a locking mechanism 3. The tie out stake 1 can comprise any material, size, shape, color, orientation etc. as long as the intended purpose of the present invention is not compromised. However, it is preferred that the tie out stake 1 is an elongated steel or aluminum rod comprising a length ranging between 8″-12″, and a thickness ranging between ⅜″-½″. According to the preferred embodiment of the present invention, the tie out stake 1 comprises a first end 1a and a second end 1b, wherein the first end 1a is positioned opposite to the second end 1b across the tie-out stake 1. Preferably, the first end 1a comprises an blunt capping surface, and the second end 1b comprises a pointy end for piercing into ground surfaces. The tie out stake further comprises a first bushing 1c, which is rotatably mounted around the tie out stake 1 adjacent to the first end 1a. Preferably, the first bushing 1c is a 1″ long metal connect, that helps connect the tie out stake 1 to the locking mechanism 3, and prevents sliding of the tie out stake 1.

As seen in FIG. 1 through FIG. 6, the leash 2 comprises a leash body 2a, a leash handle 2b, and a leash reel 2c. According to the preferred embodiment, the leash reel 2c is rotatably mounted within an interior compartment 2d of the leash body 2a, and the leash handle 2b is attached adjacent the leash body 2a. The above arrangement enables a user to operate the leash 2 comfortably within his/her grip.

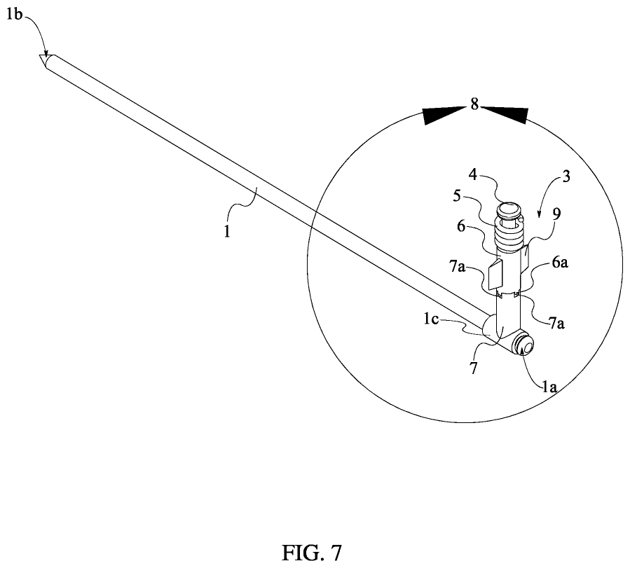

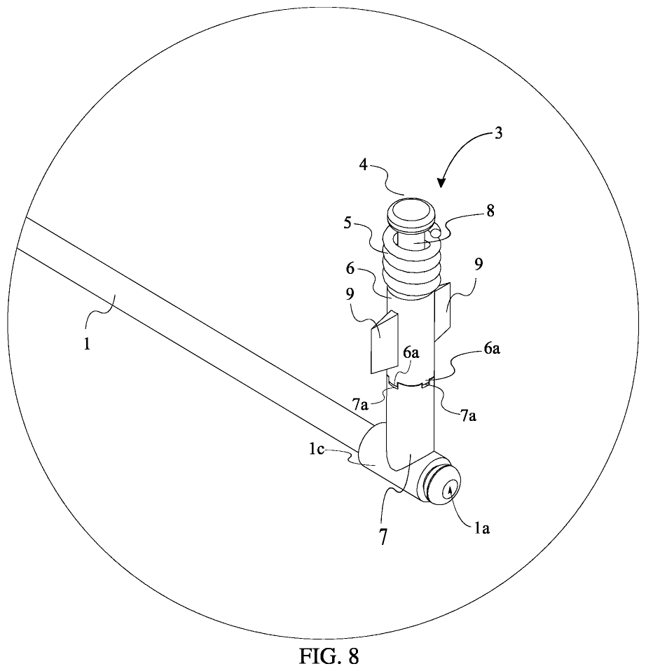

According to the preferred embodiment of the present invention, the locking mechanism 3 is rotatably coupled in between the leash handle 2b and the first bushing 1c. This arrangement ensures that the locking mechanism 3 allows rotation of the tie out stake 1 by the user, for using in two different configurations. Further, the locking mechanism 3 is integrated within the leash handle 2b, such that the locking mechanism 3 is not visible outside the leash 2. As seen in FIG. 7 and FIG. 8, the locking mechanism 3 comprises an endcap 4, a biasing device 5, a second bushing 6, a male crown gear 6a, a third bushing 7, a female crown gear 7a, an axle 8, and at least one retaining plate 9. Preferably, the endcap 4 is terminally connected to the axle 8, such that the endcap 4 provides a blunt capping surface for the axle 8. Further, the biasing device 5 and the second bushing 6 are slidably mounted along the axle 8, wherein the biasing device 5 is positioned in between the second bushing 6 and the endcap 4. This arrangement enables easy and flexible movement of both the biasing device 5 and the second bushing 6. Preferably, the biasing device 5 is a loaded spring, however any other biasing device that is known to one or ordinary skill in the art may be used. According to the preferred embodiment, the male crown gear 6a is mounted adjacent to the second bushing 6, opposite to the biasing device 5, thereby forming a first part of the locking mechanism 3. Preferably, the male crown gear 6a comprises rectangular projections that extend from the bottom face of the second bushing 6, that are spaced 90 degrees apart, around the circumference of the second bushing 6.

Continuing with the preferred embodiment, the third bushing 7 is connected in between the axle 8 and the first bushing 1c. Preferably, the third bushing 7 is spot welded to the first bushing 1c. However, any other method that is known to one of ordinary skill in the art may be employed to connect the first bushing 1c and the third bushing 7. Further, the female crown gear 7a is mounted adjacent the third bushing 7, opposite to the tie out stake 1, thereby forming a second part of the locking mechanism 3. Preferably, the female crown gear 7a comprises rectangular indentations that extend around the top face of the third bushing 7, that are spaced 90 degrees apart around the circumference of the third bushing 7. Thus, the specific shape and arrangement of the male crown gear 6a and the female crown gear 7a, allows the male crown gear 6a to engage into the female crown gear 7a, to form a lock.

According to the preferred embodiment of the present invention, the at least one retaining plate 9 is connected in between the second bushing 6a and the leash handle 2b. The retaining plate 9 can be of any shape, size, material, or orientation, that is known to one of ordinary skill in the art, as long as the intended purpose of the present invention is not hindered. However, as seen in FIG. 7 and FIG. 8, the retaining plate 9 is a wedge-shaped protrusion that extends from the second bushing 6 that prevents rotation of the second bushing 6 within the leash handle 2b, thereby enabling proper operation of the tie out stake 1 and the locking mechanism 3. According to the preferred embodiment, in order for the locking mechanism 3 to work properly, the second bushing 6 is rotatably coupled to the third bushing 7, and the male crown gear 6a fits in the female crown gear 7a to create a locked position at every 90 degrees rotation of the third bushing 7. However, any other locking mechanism that is known to one of ordinary skill in the art may be used, as long as the intended purpose of the present invention is not hindered. Further, in order to rotate the third bushing 7, the biasing device 5 is operatively coupled to the third bushing 7. Thus, by pulling down the first end 1a of the tie out stake 1, the biasing device 5 temporarily enables the female crown gear 7a to release from the male crown gear 6a, and this allows rotation of the tie out stake 1 along a horizontal axis. In other words, operating the biasing device 5 enables disengagement and rotation of the female crown gear 7a, which leads to angular displacement of the tie out stake 1 in the horizontal direction. Further, releasing the biasing device reengages the female crown gear 7a with the male crown gear 6a, thereby locking the tie out stake 1 after 90 degrees of rotation.

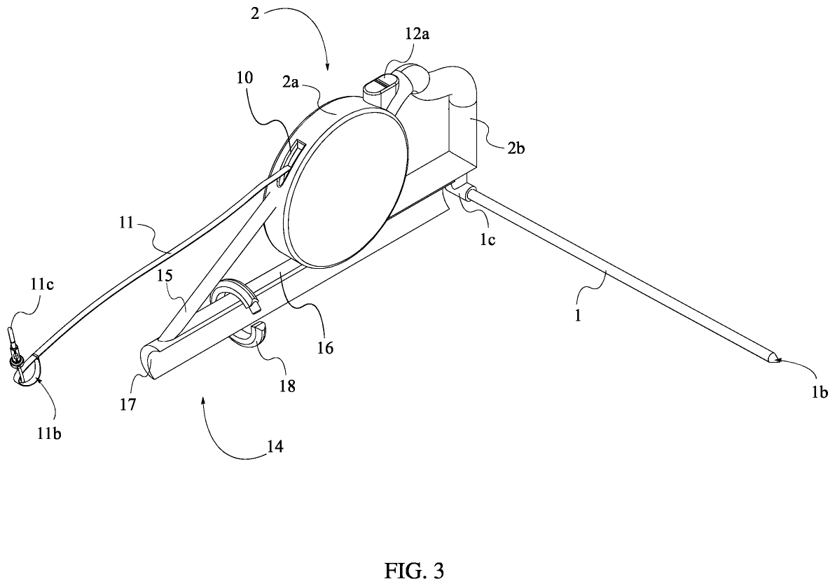

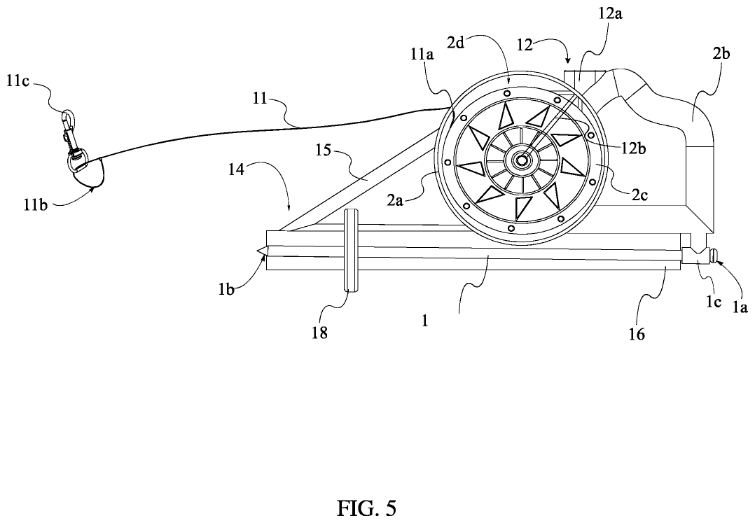

As seen in FIG. 3 and FIG. 5, the leash 2 further comprises a reel hole 10, a cable 11, and a reel control assembly 12. According to a preferred embodiment of the present invention, the reel hole 10 traverses through the leash body 2a into the interior compartment 2d. The reel hole 10 can be of any size, shape etc. as long as the intended purpose of the present invention is not hindered. Preferably, the reel hole 10 is big enough for the cable 11 to pass through or traverse through the leash body 2a. Similarly, the cable 11 may comprise any material, length, shape, or design that is known to one of ordinary skill in the art. Preferably, a first end 11a of the cable 11 is tethered to the leash reel 2c, and a second end 11b of the cable is threaded through the reel hole 10. The first end 11a of the cable 11, ensures that the cable 11 reels around the leash reel 2c, and the second end 11b of the cable is connected to a collar fastener 11c that could be tethered to a dog's collar. Preferably, the collar fastener 11c is a D-clip or a small carabiner. However, any other fastener that is known to one of ordinary skill in the art may be utilized for connecting the cable 11 to the dog collar.

According to the preferred embodiment, the reel control assembly 12 is integrated into the leash body 2a, and the reel control assembly 12 is operatively coupled to the leash reel 2c. This arrangement is so that the reel control assembly 12 governs playing out or reeling in a length of the cable 11. Continuing with the preferred embodiment of the present invention, the reel control assembly 12 further comprises a human interface device 12a and a controller assembly 12b. As seen in FIG. 1 through FIG. 6, the human interface device 12a is mounted onto the leash body 2a, and is positioned adjacent to the leash handle 2b, such that the human interface device 12a is conveniently placed for easy handling by the user. Furthermore, as seen in FIG. 5, the controller assembly 12b is connected in between the human interface device 12a and the leash reel 2c. Preferably, the controller assembly 12b assists in the smooth reeling out and reeling in of the cable 11 in accordance with the operation of the human interface device 12a.

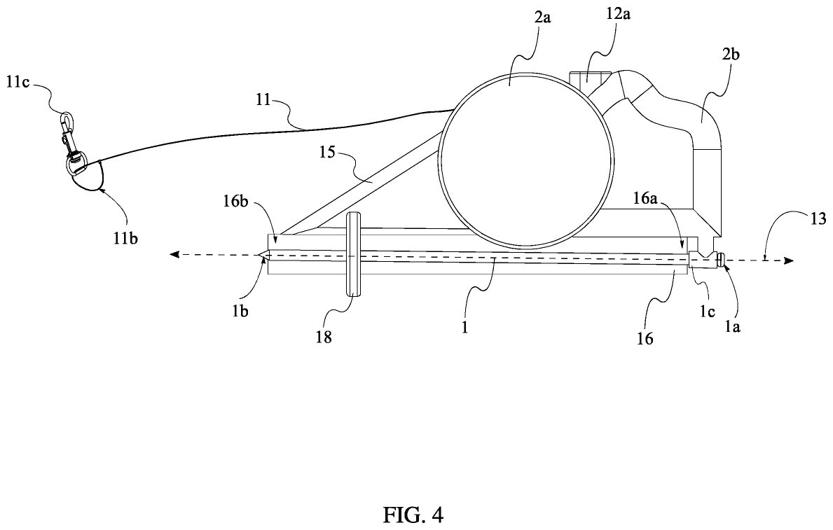

It is an aim of the present invention, to have the tie out stake 1 built into the leash handle 2a and be able to alternate the position of the tie out stake 1 between an open configuration or tie out mode, and a collapsed configuration or stow mode. Accordingly, as seen in FIG. 4 through FIG. 6, when the tie-out stake 1 is in the closed configuration, the tie-out stake 1 is positioned adjacent the leash body 2a and the locking mechanism 3 retains the tie-out stake in an orientation parallel to a horizontal axis 13 of the leash body 2a. In other words, during the stow mode, the tie out stake 1 runs parallel to the bottom of the leash 2.

Further, as seen in FIG. 1 through FIG. 3, when the tie-out stake 1 is in an open configuration, the tie-out stake 1 is positioned angularly offset from the leash body 2a, and the locking mechanism 3 retains the tie-out stake perpendicularly to the horizontal axis 13 of the leash body 2a. In other words, during tie out mode, the tie out stake 1 would rotate away from the leash 2 and lock at 90 degrees, so that the tie out stake 1 could be inserted into the ground and the leash 2 would be free to rotate on the stake allowing the leash body 2a to rotate with whichever direction the pet is.

It is an aim of the present invention to hold the tie out stake 1 securely in a protective place and avoid accidents, when the tie out stake 1 is not in use. Accordingly, the dog leash further comprises a shroud 14. The shroud 14 can be of any size, shape, material, orientation etc., that is known to one of ordinary skill in the art, as long as the intended purpose of the present invention is not hindered. However, it is preferred that the shroud 14 comprises a material that is compatible with the material of the leash body 2a. According to the preferred embodiment, the shroud 14 comprises a support arm 15, a sheath 16, a C-channel 17, and a fastener 18. Preferably, a fixed end 16a of the sheath 16 is laterally attached to the leash body 2a and a free end 16b of the sheath 16 is positioned opposite to the fixed end 16a, across the sheath 16. This enables for the smooth working of the present invention with a compact design. Further, the C-channel 17 normally traverses into the sheath 16, thereby forming a protective enclosure for the tie out stake 1, during the closed configuration. Furthermore, the sheath 16 is positioned offset from the leash handle 2b across the leash body 2a, and the support arm 15 is connected in between the leash body 2a and the free end 16b. This is so that the support arm 15 provides enough structural support for the sheath 16 and balances the weight of the shroud 14 with the tie out stake 1. According to the preferred embodiment of the present invention, the fastener 18 is mounted across the C-channel 17 for securely holding the tie out stake 1 within the C-channel 17. Preferably, the fastener 18 is a nylon strap that is mounted on the sheath 16 that extends around the C-channel 17. Further, the fastener may comprise a male snap button and a female snap button attached at the two ends of the nylon strap, that snaps together and fastens the tie out stake 1 to the shroud, in the closed/stow mode. However, any other fastener or fastening technique that is known to one of ordinary skill in the art may be utilized for securing the tie out stake 1 to the C-channel 17. In other words, when the tie out stake 1 is in the closed configuration, the tie out stake 1 is positioned within the C-channel 17, and the fastener retains the tie out stake 1 within the C-channel 17.

Although the invention has been explained in relation to its preferred embodiment, it is to be understood that many other possible modifications and variations can be made without departing from the spirit and scope of the invention as hereinafter claimed.

What is claimed is:

1. A retractable dog leash with a built-in tie-out stake, comprising:
a tie-out stake;
a leash;
a locking mechanism;
the tie out stake comprising a first end, a second end, and a first bushing;
the leash comprising a leash body, a leash handle, and a leash reel;
the first end being positioned opposite to the second end across the tie-out stake;
the first bushing being rotatably mounted around the tie out stake, adjacent the first end;
the leash reel being rotatably mounted within an interior compartment of the leash body;
the leash handle being attached adjacent the leash body;
the locking mechanism being rotatably coupled in between the leash handle and the first bushing; and
the locking mechanism being integrated within the leash handle.

2. The dog leash of claim 1, comprising:
the locking mechanism comprising an endcap, a biasing device, a second bushing, a male crown gear, a third bushing, a female crown gear, an axle, and at least one retaining plate;
the endcap being terminally connected to the axle;
the biasing device and the second bushing being slidably mounted along the axle;
the biasing device being positioned in between the second bushing and the endcap;
the male crown gear being mounted adjacent to the second bushing, opposite to the biasing device;
the third bushing being connected in between the axle and the tie-out stake;
the female crown gear being mounted adjacent to the third bushing, opposite to the tie-out steak;
the male crown gear engaging into the female crown gear; and
the retaining plate being connected in between the second bushing and the handle.

3. The dog leash of claim 2, wherein operating the biasing device enables rotation of the female crown gear which leads to angular displacement of the tie-out stake in the horizontal direction.

4. The dog leash of claim 1, further comprising:
the leash comprising a reel hole, a cable, and a reel control assembly;
the reel hole traversing through the leash body into the interior compartment;
a first end of the cable being tethered to the leash reel;
a second end of the cable being threaded through the reel hole;
the reel control assembly being integrated into the leash body; and
the reel control assembly being operatively coupled to the leash reel, wherein the reel control assembly governs playing out or reeling in a length of the cable.

5. The dog leash of claim 4, wherein the second end of the cable is tethered to a collar fastener.

6. The dog leash of claim 4, further comprising:
the reel control assembly comprising a user interface device and a controller assembly;
the human interface device being mounted onto the leash body;
the human interface device being positioned adjacent to the handle; and
the controller assembly being connected in between the human interface device and the leash reel.

7. The dog leash of claim 1, wherein the tie-out stake is in a closed configuration:
the tie-out stake being positioned adjacent the leash body; and
the locking mechanism retaining the tie-out stake in an orientation parallel to a longitudinal axis of the leash body.

8. The dog leash of claim 1, wherein the tie-out stake is in an open configuration:
the tie-out stake being positioned angularly offset from the leash body; and
the locking mechanism retaining the tie-out stake perpendicularly to a longitudinal axis of the leash body.

9. The dog leash of claim 1, further comprising:
a shroud;
the shroud comprising a support arm, a sheath, a C-channel, and a fastener;
a fixed end of the sheath being laterally attached to the leash body;
the sheath being positioned offset from the handle across the leash body;
a free end of the sheath being positioned opposite to the fixed end, across the sheath;
the support arm being connected in between the leash body and the free end;
the C-channel normally traversing into the sheath; and
the fastener being mounted across the C-channel.

10. The dog leash of claim 8, wherein the tie-out stake is in a closed configuration:
the tie-out stake being positioned within the C-channel; and
the fastener retaining the tie-out steak within the C-channel.

11. The dog leash of claim 1, wherein the second end of the tie out stake is pointed.

12. A retractable dog leash with a built-in tie-out stake, comprising:
a tie-out stake;
a leash;
a locking mechanism;
the tie out stake comprising a first end and a second end;
the leash comprising a leash body, a leash handle, and a leash reel;
the leash handle being attached adjacent the leash body;
the locking mechanism being rotatably coupled in between the leash handle and the first end; and
the locking mechanism being integrated within the leash handle.

13. The dog leash of claim 12, wherein the tie-out stake is in a closed configuration:
the tie-out stake being positioned adjacent the leash body; and
the locking mechanism retaining the tie-out stake in an orientation parallel to a longitudinal axis of the leash body.

14. The dog leash of claim 12, wherein the tie-out stake is in an open configuration:
the tie-out stake being positioned angularly offset from the leash body; and
the locking mechanism retaining the tie-out stake perpendicularly to a longitudinal axis of the leash body.

15. The dog leash of claim 12, further comprising:
a shroud;
the shroud comprising a support arm, a sheath, a C-channel, and a fastener;
a fixed end of the sheath being laterally attached to the leash body;
the sheath being positioned offset from the handle across the leash body;
a free end of the sheath being positioned opposite to the fixed end, across the sheath;
the support arm being connected in between the leash body and the free end;
the C-channel normally traversing into the sheath; and
the fastener being mounted across the C-channel.

16. The dog leash of claim 15, wherein the tie-out stake is in a closed configuration:
the tie-out stake being positioned within the C-channel; and
the fastener retaining the tie-out steak within the C-channel.
